(19) United States
(12) Patent Application Publication
(10) Pub. No.: US 2026/0084164 A1
(43) Pub. Date: Mar. 26, 2026

(54) CYCLONE NOZZLE

(71) Applicant: JENG SHENG CO., LTD., Taichung City (TW)

(72) Inventor: Kuo-Chin CHIANG, Taichung City (TW)

(21) Appl. No.: 19/294,627

(22) Filed: Aug. 8, 2025

(30) Foreign Application Priority Data
Sep. 25, 2024 (TW) 113136340

(51) Int. Cl. B05B 1/34; B05B 1/00

(52) U.S. Cl. CPC B05B 1/341; B05B 1/005

(57) ABSTRACT

A cyclone nozzle includes a cover tube, a jet assembly and at least one intake hole. The cover tube defines an internal space, a first end opening and a second end opening. The jet assembly is disposed within the internal space and includes a gas hose and a gas supply unit. One end of the gas hose is connected with the gas supply unit, and the other end is a free end and includes a gas outlet located in the internal space. The at least one intake hole penetrates through the cover tube and located between the gas outlet and the second end opening. Gas ejected from the gas outlet toward the second end opening flows past the at least one intake hole, generating a pressure difference that draws an external air into the internal space through the at least one intake hole.

### BACKGROUND OF THE INVENTION

### Field of the Invention

The present invention relates to a cyclone nozzle.

### Description of the Prior Art

Air guns are commonly used with high-pressure airflow to remove dirt, dust, or grease from factory equipment, electronic devices, vehicles, construction sites, and similar environments. The powerful airflow provides excellent cleaning efficiency, and cleaning personnel do not need to come into direct contact with the contaminants. Moreover, the air gun can easily reach into narrow spaces that are inaccessible by hand, making this cleaning method widely adopted across various environments. However, such air guns typically feature a simple structure with a single air hose for ejecting high-pressure airflow, and there has been little further development on how to enhance the cleaning efficiency.

The present invention is, therefore, arisen to obviate or at least mitigate the above-mentioned disadvantages.

### SUMMARY OF THE INVENTION

The main object of the present invention is to provide a cyclone nozzle, which can effectively eject a cyclonic airflow and, in cooperation with an intake hole, draw in external air to thereby enhance the volume of ejected airflow.

To achieve the above and other objects, the present invention provides a cyclone nozzle, including: a cover tube, a jet assembly and at least one intake hole. The cover tube defines an internal space, a first end opening and a second end opening which are in communication with one another. The jet assembly is disposed within the internal space through the first end opening and includes a gas hose and a gas supply unit. One end of the gas hose is connected with the gas supply unit, and the other end of the gas hose is a free end and includes a gas outlet located in the internal space. The at least one intake hole penetrates through the cover tube and located between the gas outlet and the second end opening. Gas ejected from the gas outlet toward the second end opening flows past the at least one intake hole, generating a pressure difference that draws an external air located outside the cover tube into the internal space through the at least one intake hole, and the external air flows together with the gas ejected from the gas outlet through the second end opening.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of FIG. 1;

FIG. 3 is a cross-sectional view of FIG. 1;

FIG. 4 is a partial enlargement of FIG. 3; and

FIG. 5 is a partial cross-sectional view of a preferable embodiment of the present invention.

### DETAILED DESCRIPTION OF THE PREFERRED EMBODIMENTS

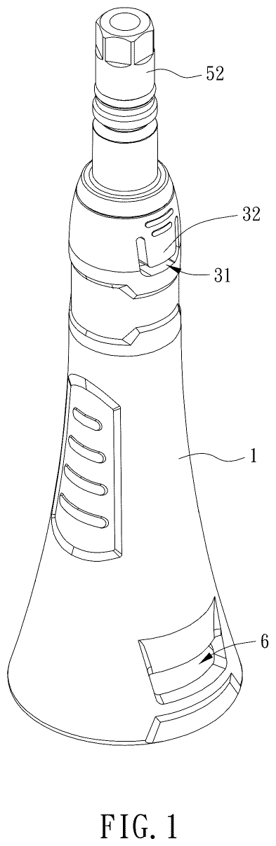

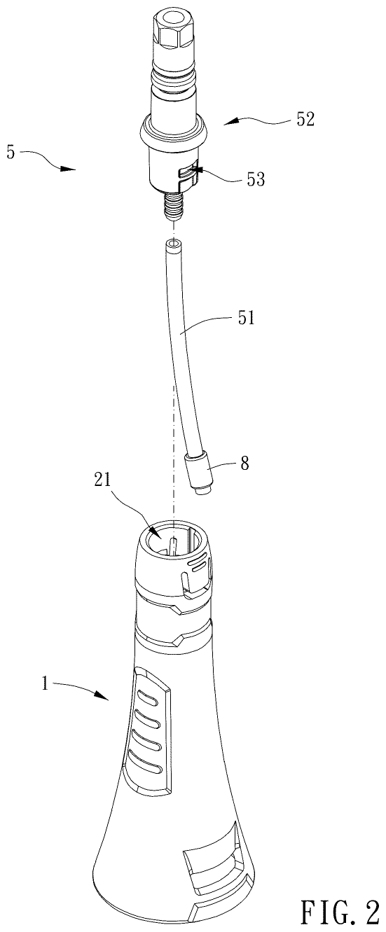

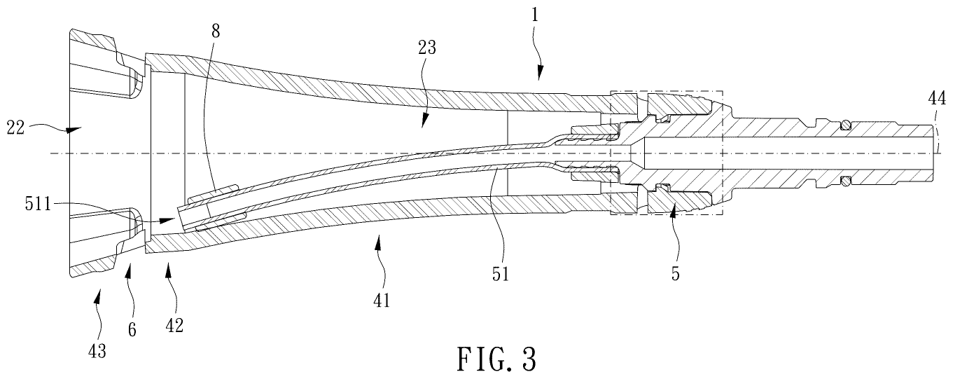

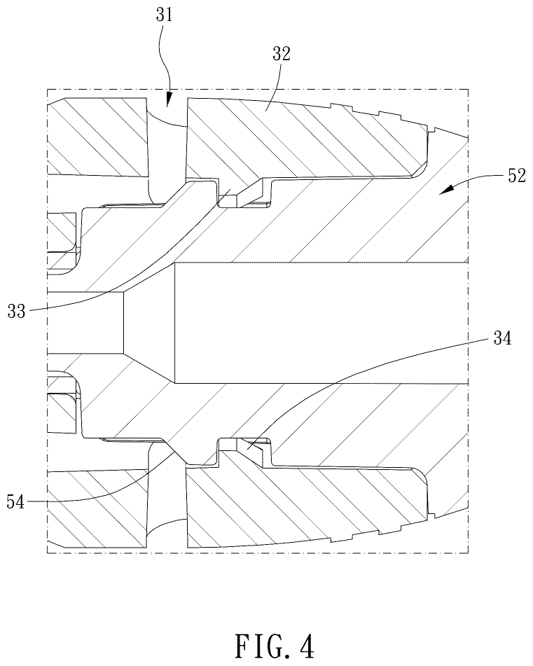

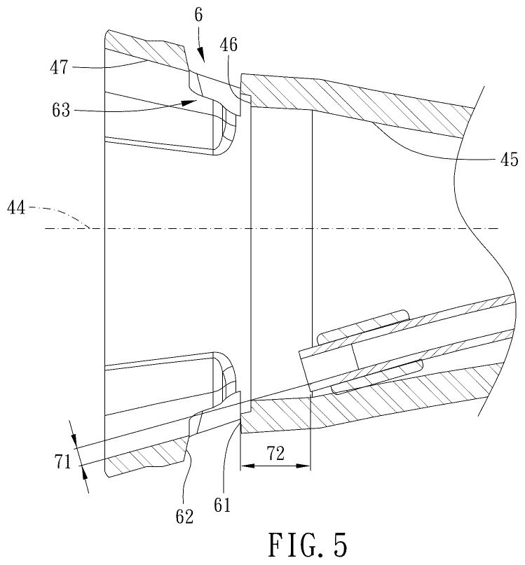

Please refer to FIGS. 1 to 5 for a preferable embodiment of the present invention. A cyclone nozzle of the present invention includes a cover tube 1, a jet assembly 5 and at least one intake hole 6.

The cover tube 1 defines an internal space 23, a first end opening 21 and a second end opening 22 which are in communication with one another. The jet assembly 5 is disposed within the internal space 23 through the first end opening 21, and the jet assembly 5 includes a gas hose 51 and a gas supply unit 52. One end of the gas hose 51 is connected with the gas supply unit 52, and the other end of the gas hose 51 is a free end and includes a gas outlet 511 located in the internal space 23.

In this embodiment, the gas supply unit 52 is a fitting and configured to be connected with a gas source, and the gas supply unit 52 is disposed through the first end opening 21 and connected with the cover tube 1. Specifically, the gas supply unit 52 includes an engaging groove 53 recessed thereon, the cover tube 1 includes at least one cutting slot 31 disposed therethrough to form at least one at least one elastic portion 32, and at least one rib 33 protruding from the at least one elastic portion 32 is engaged within the engaging groove 53, so that the gas supply unit 52 is rotatably assembled to the cover tube 1. Moreover, the gas supply unit 52 further includes a first inclined wall 54 adjacent to the engaging groove 53 and facing toward the second end opening 22, the at least one rib 33 has a second inclined wall 34 facing toward the first end opening 21, and the first inclined wall 54 corresponds to the second inclined wall 34. As such, during the assembling process, the gas supply unit 52 can be smoothly inserted into the first end opening 21.

When the gas is ejected from the gas outlet 511 of the gas hose 51, the free end of the gas hose 51 is subjected to a reaction force and swings within the internal space 23, thereby generating a spiral airflow that is ejected from the second end opening 22. The spiral airflow can cover the area to be cleaned more widely and comprehensively, and can rapidly remove dirt away from the cleaning area from multiple directions, thus achieving excellent cleaning efficiency.

The jet assembly 5 preferably further includes a sleeve 8 sleeved to the free end of the gas hose 51 to increase a weight of the free end of the gas hose 51 like a counterweight, thereby enhancing the swinging inertia. Meanwhile, when the free end of the gas hose 51 strikes and collides against the inner surface of the cover tube 1 due to the swinging motion, the sleeve 8 can effectively protect the structural integrity of the free end of the gas hose 51. A thickness of the sleeve 8 is greater than a thickness of the gas hose 51.

The at least one intake hole 6 is disposed through the cover tube 1 and located between the gas outlet 511 and the second end opening 22. Gas ejected from the gas outlet 511 toward the second end opening 22 flows past the at least one intake hole 6, generating a pressure difference that draws an external air located outside the cover tube 1 into the internal space 23 through the at least one intake hole 6, and the external air flows together with the gas ejected from the gas outlet 511 through the second end opening 22, thereby greatly increasing the air volume ejected from the second end opening 22 to effectively enhance the cleaning capability and coverage area.

An inner diametrical dimension of the cover tube 1 is at least partially enlarged in a direction from the first end opening 21 toward the second end opening 22, so as to effectively guide the airflow in the internal space 23 to radially eject outward, aiming to cover a wider area.

Furthermore, the cover tube 1 includes a first tapered section 41, a transition section 42 and a second tapered section 43, and the transition section 42 is connected between the first tapered section 41 and the second tapered section 43. The transition section 42 extends straightly, the first tapered section 41 has the first end opening 21 disposed thereon, and the second tapered section 43 has the second end opening 22 disposed thereon. The at least one intake hole 6 is disposed on the second tapered section 43. A taper angle of the first tapered section 41 is different from a taper angle of the second tapered section 43, for example, the taper angle of the second tapered section 43 is greater than the taper angle of the first tapered section 41.

The at least one intake hole 6 includes an inner opening 63 located at an inner side of the cover tube 1. when the gas is ejected from the gas hose 51 and the free end of the gas hose 51 is moved violently and comes into contact with the cover tube 1, a gap 71 is formed between a side of an edge defining the gas outlet 511 close to the cover tube 1 and a position of the inner opening 63 of the at least one intake hole 6 in a direction vertical to an opening direction of the gas outlet 511, an interval 72 is maintained between the gas outlet 511 and the inner opening 63 of the at least one intake hole 6 in the direction from the first end opening 21 toward the second end opening 22, such that the interval 72 and the gap 71 allow the high-speed airflow ejected from the gas outlet 511 to stably flow past the inner opening 63 of the at least one intake hole 6, thereby generating a pressure difference to induce negative pressure suction at the at least one intake hole 6 and draw external air inward to flow together toward the second end opening 22. The interval 72 is greater than the gap 71, for example, a ration of the interval 72 to the gap 71 may be greater than 2, and the interval 72 may be greater than a length of the inner opening 63 of the at least one intake hole 6 in the direction from the first end opening 21 toward the second end opening 22.

In this embodiment, the cover tube 1 defines a central axis 44, an inner surface of the cover tube 1 includes a first stepped surface 45, a transition surface 46 and a second stepped surface 47, and the transition surface 46 is connected between the first stepped surface 45 and the second stepped surface 47. The first stepped surface 45 is closer to the central axis 44 than the second stepped surface 47, and the second stepped surface 47 is closer to the second end opening 22 than the first stepped surface 45. When the gas is ejected from the gas hose 51, the free end of the gas hose 51 is moved violently and comes into contact with the first stepped surface 45, and the at least one intake hole 6 is disposed on the second stepped surface 47. In other words, the first stepped surface 45, the transition surface 46 and the second stepped surface 47 are configured in a stepped arrangement, which allows the gap 71 to be quickly and precisely controlled. An angle between the transition surface 46 and the second stepped surface 47 is an obtuse angle so that the airflow can flow more smoothly.

Preferably, a wall portion defining the at least one intake hole 6 includes a first sidewall 61 and a second sidewall 62 opposite to each other in the direction from the first end opening 21 toward the second end opening 22, and the second sidewall 62 is closer to the second end opening 22 than the first sidewall 61. In a direction vertical to the direction from the first end opening 21 toward the second end opening 22, the second sidewall 62 is located at an outer side of the first sidewall 61, so that the second sidewall 62 can effectively guide external air into the at least one intake hole 6. In this embodiment, in the direction vertical to the direction from the first end opening 21 toward the second end opening 22, a distance that the second sidewall 62 protrudes beyond the first sidewall 61 is greater than the gap 71 and smaller than the interval 72.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A cyclone nozzle, including:
a cover tube, defining an internal space, a first end opening and a second end opening which are in communication with one another;
a jet assembly, disposed within the internal space through the first end opening, including a gas hose and a gas supply unit, one end of the gas hose connected with the gas supply unit, the other end of the gas hose being a free end and including a gas outlet located in the internal space; and
at least one intake hole, penetrating through the cover tube and located between the gas outlet and the second end opening;
wherein gas ejected from the gas outlet toward the second end opening flows past the at least one intake hole, generating a pressure difference that draws an external air located outside the cover tube into the internal space through the at least one intake hole, and the external air flows together with the gas ejected from the gas outlet through the second end opening;
wherein an inner diametrical dimension of the cover tube is at least partially enlarged in a direction from the first end opening toward the second end opening, the cover tube includes a first tapered section, a transition section and a second tapered section, the transition section is connected between the first tapered section and the second tapered section, the first tapered section has the first end opening disposed thereon, the second tapered section has the second end opening disposed thereon, the at least one intake hole is disposed on the second tapered section, and a taper angle of the first tapered section is different from a taper angle of the second tapered section.

2. The cyclone nozzle of claim 1, wherein the jet assembly further includes a sleeve sleeved to the free end of the gas hose.

3. The cyclone nozzle of claim 1, wherein the gas supply unit is a fitting and configured to be connected with a gas source, and the gas supply unit is disposed through the first end opening and connected with the cover tube.

4. The cyclone nozzle of claim 3, wherein the gas supply unit includes an engaging groove recessed thereon, the cover tube includes at least one cutting slot disposed therethrough to form at least one elastic portion, and at least one rib protruding from the at least one elastic portion is engaged within the engaging groove.

5. The cyclone nozzle of claim 4, wherein the jet assembly further includes a sleeve sleeved to the free end of the gas hose; a wall portion defining the at least one intake hole includes a first sidewall and a second sidewall opposite to each other in the direction from the first end opening toward the second end opening, the second sidewall is closer to the second end opening than the first sidewall; in a direction vertical to the direction from the first end opening toward the second end opening, the second sidewall is located at an outer side of the first sidewall; the at least one intake hole includes an inner opening located at an inner side of the cover tube, when the gas is ejected from the gas hose and the free end of the gas hose is moved violently and comes into contact with the cover tube, a gap is formed between a side of an inner surface of the gas hose close to the cover tube and a position of the inner opening of the at least one intake hole, and an interval is maintained between the gas outlet and the inner opening of the at least one intake hole in the direction from the first end opening toward the second end opening; the interval is greater than the gap; the cover tube defines a central axis, an inner surface of the cover tube includes a first stepped surface, a transition surface and a second stepped surface, the transition surface is connected between the first stepped surface and the second stepped surface, the first stepped surface is closer to the central axis than the second stepped surface, the second stepped surface is closer to the second end opening than the first stepped surface, when the gas is ejected from the gas hose, the free end of the gas hose is moved violently and comes into contact with the first stepped surface, the at least one intake hole is disposed on the second stepped surface; the gas supply unit further includes a first inclined wall adjacent to the engaging groove and facing toward the second end opening, the at least one rib has a second inclined wall facing toward the first end opening, the first inclined wall corresponds to the second inclined wall; a thickness of the sleeve is greater than a thickness of the gas hose; the transition section extends straightly; the interval is greater than a length of the inner opening of the at least one intake hole in the direction from the first end opening toward the second end opening; a ratio of the interval to the gap is greater than 2; the taper angle of the second tapered section is greater than the taper angle of the first tapered section; an angle between the transition surface and the second stepped surface is an obtuse angle; and in the direction vertical to the direction from the first end opening toward the second end opening, a distance that the second sidewall protrudes beyond the first sidewall is greater than the gap and smaller than the interval.

6. A cyclone nozzle, including:
a cover tube, defining an internal space, a first end opening and a second end opening which are in communication with one another;
a jet assembly, disposed within the internal space through the first end opening, including a gas hose and a gas supply unit, one end of the gas hose connected with the gas supply unit, the other end of the gas hose being a free end and including a gas outlet located in the internal space; and
at least one intake hole, penetrating through the cover tube and located between the gas outlet and the second end opening;
wherein gas ejected from the gas outlet toward the second end opening flows past the at least one intake hole, generating a pressure difference that draws an external air located outside the cover tube into the internal space through the at least one intake hole, and the external air flows together with the gas ejected from the gas outlet through the second end opening;
wherein a wall portion defining the at least one intake hole includes a first sidewall and a second sidewall opposite to each other in a direction from the first end opening toward the second end opening, the second sidewall is closer to the second end opening than the first sidewall, and in a direction vertical to the direction from the first end opening toward the second end opening, the second sidewall is located at an outer side of the first sidewall.

7. A cyclone nozzle including:
a cover tube, defining an internal space, a first end opening and a second end opening which are in communication with one another;
a jet assembly, disposed within the internal space through the first end opening, including a gas hose and a gas supply unit, one end of the gas hose connected with the gas supply unit, the other end of the gas hose being a free end and including a gas outlet located in the internal space; and
at least one intake hole, penetrating through the cover tube and located between the gas outlet and the second end opening;
wherein gas ejected from the gas outlet toward the second end opening flows past the at least one intake hole, generating a pressure difference that draws an external air located outside the cover tube into the internal space through the at least one intake hole, and the external air flows together with the gas ejected from the gas outlet through the second end opening;
wherein the at least one intake hole includes an inner opening located at an inner side of the cover tube, when the gas is ejected from the gas hose and the free end of the gas hose is moved violently and comes into contact with the cover tube, a gap is formed between a side of an edge defining the gas outlet close to the cover tube and a position of the inner opening of the at least one intake hole in a direction vertical to an opening direction of the gas outlet, and an interval is maintained between the gas outlet and the inner opening of the at least one intake hole in a direction from the first end opening toward the second end opening; and the interval is greater than the gap.

8. The cyclone nozzle of claim 7, wherein the cover tube defines a central axis, an inner surface of the cover tube includes a first stepped surface, a transition surface and a second stepped surface, the transition surface is connected between the first stepped surface and the second stepped surface, the first stepped surface is closer to the central axis than the second stepped surface, the second stepped surface is closer to the second end opening than the first stepped surface, when the gas is ejected from the gas hose, the free end of the gas hose is moved violently and comes into contact with the first stepped surface, and the at least one intake hole is disposed on the second stepped surface.
